(19) United States
(12) Patent Application Publication
(10) Pub. No.: US 2003/0216956 A1
(43) Pub. Date: Nov. 20, 2003

(54) Method and system for marketing to potential customers

(76) Inventors: Richard T. Smith, Bloomfield Hills, MI (US); Ronald T. Smith, Bloomfield Hills, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/465,094

(22) Filed: Jun. 19, 2003

Related U.S. Application Data
(63) Continuation of application No. 09/503,627, filed on Feb. 11, 2000.
(60) Provisional application No. 60/119,847, filed on Feb. 12, 1999.

(51) Int. Cl. G06F 17/60

(52) U.S. Cl. 705/10

(57) ABSTRACT

A method and system for marketing to potential customers for major decision goods and/or services purchases based on knowledge of the potential customers as purchasing units includes combining information from public information, purchased private information, and recorded behavior and actions observed with the marketer, seller or others as an input, then transmitting a marketing profile questionnaire about specific characteristics or preferences of purchasing units for goods or services to predetermined purchasing units meeting minimum criteria to collect and define purchasing units to whom marketing is performed. Control logic determines if any of the predetermined purchasing units have purchased in the past, or subsequently return the marketing profile questionnaire or make a purchase thereafter. If any one of the predetermined purchasing units purchased or purchases the goods or services of interest, a predetermined marketing communication is transmitted to the purchasing unit based on that purchase and information is stored. If any one of the predetermined purchasing units return the marketing profile questionnaire, information about each such purchasing unit is stored and predetermined marketing communications are transmitted based on the purchasing unit response to the marketing profile questionnaire. Periodic determinations also convert certain purchasing units to an inactive status.

### CROSS REFERENCE TO RELATED APPLICATION

This application is related to U.S. Provisional Patent Application No. 60/119,847, filed Feb. 12, 1999, entitled Database Marketing Funnel.

### TECHNICAL FIELD

This invention relates to methods and systems for marketing to customers and potential customers for major decision goods or services based on knowledge of the customers or potential customers.

### BACKGROUND OF THE INVENTION

While the marketing communication process has evolved dramatically from its beginnings, the impact of radio, television, database and on-line marketing only foreshadow the potential for growth within new media environments. From the earliest forms of marketing communications to today's excitement surrounding on-line marketing, the tools useful to marketing communications have without a doubt evolved. However, the marketing paradigm itself has remained virtually unchanged.

Until recently, all marketing communication was delivered through a so-called “one-way marketing” model that worked as follows: messages were designed for and delivered against a vaguely defined “target audience” using a mix of one-way media tools. This one-way marketing process is characterized by a lack of focus and low productivity. All customers within the defined audience are, due to a lack of specific customer information, assumed to be of equal (or near equal) value to the marketer. In this scenario, the media delivery and the market response are graded against a share of market goal. Regardless of the vehicle, and no matter how targeted the delivery, the starting point is still an audience of substantially undifferentiated users.

In some cases, marketers would survey potential target customers and/or past customers for further information on preferences, but only after the targets or past customers had been provided by other means, and not pro-actively.

Thus, there exists a need for pro-actively identifying customers and potential customers as high probability future purchasers based on information known about customers and their previous purchasing behavior relative to the seller, marketer and others in the position of the seller or marketer. Specific marketing communications can then be sent to the identified potential purchasers under a defined program, thereby lowering the cost of marketing as well as increasing the amount of purchases of products or services, particularly in the category of major decision purchases, such as cruise vacations, automobiles, and other relatively high purchase cost items, or relatively long purchase decision windows, such as enrolling in a university or joining the military.

### SUMMARY OF THE INVENTION

It is an object of the present invention to provide a method and system for marketing potential customers for major decision purchases of goods or services based on a predictive behavioral model of a purchasing unit both on an aggregate of purchasing units and on a single purchasing unit basis. A purchasing unit can be an individual, a household, a small business, a department of a large business, or any individual person or group of people who makes a purchasing decision of a seller's product or service.

In carrying out the above objects and other objects, features, and advantages of the present invention, a method is described for marketing customers and potential customers as purchasing units for major decision purchases of goods or services based on an input of information on the purchasing unit combined from (1) public information, (2) purchased private information, (3) information recorded from observation of the behavior and actions of the purchasing unit interacting with the observer and others, and (4) recorded market research or survey data received directly from the purchasing unit on a pro-active basis.

The method includes transmitting a marketing profile questionnaire to predetermined purchasing units meeting minimum criteria and determining if any one of the predetermined purchasing units performs one of either (a) purchasing the goods or services or (b) returning the marketing profile questionnaire. The method continues with subsequently transmitting predetermined marketing communications based on the purchase if any one of the predetermined purchasing units purchase the goods and/or services. The method also includes storing information about the purchasing units in a profiled prospect database and transmitting predetermined marketing communications to the purchasing units based on a response to the marketing profile questionnaire if any one of the predetermined purchasing units returned the marketing profile questionnaire. The method also comprises steps of tracking the amount of time that predetermined marketing communications have been sent to the purchasing unit and, if no purchase and/or other identified behavior or action has been made in the time allotted or if no subsequent purchase has been made in a predetermined time allotted, then the purchasing unit information is placed in an inactive status in a storage such as in a database of inactive purchasing units or the like. Subsequent restoration of the inactive purchasing unit information may be restored to the active database by purchase, contact, and possible other activities that are passive to the system or method.

In further carrying out the above object and other objects, features, and advantages of the present invention, a system is also provided for carrying out the steps of the above-described method.

The system of the present invention includes means for initially transmitting a marketing profile questionnaire about specific goods or services sold by a seller or group of sellers to predetermined purchasing units meeting minimum criteria, including hardware and software associated with that task. The system further includes a control logic via computer programming or other means for determining if any of the predetermined purchasing units either (a) purchase the goods and/or services and/or (b) return the marketing profile questionnaire, then determining whether to initiate transmission of predetermined marketing communications to each purchasing unit based on the purchase if any one of the predetermined purchasing units (a) purchase the goods or services and/or (b) any one of the predetermined purchasing units returns the marketing profile questionnaire, and then storing information about the purchasing units in an active profiled prospect database. Subsequently a process is used to determine whether to initiate transmission of predetermined marketing communications to a single purchasing unit based on the purchasing unit's response to the marketing profile questionnaire.

The system further provides for a time period after which, if no purchase is made (or if no subsequent purchase is made) or if no other identified behavior or action is performed by a customer purchasing unit, the purchasing unit information is moved to an inactive status in an inactive database (or by other means converted to be inactive) and not reviewed in the ordinary course of activity.

The above object and other objects, features, and advantages of the present invention are readily apparent from the following detailed description of the best mode for carrying out the invention when taken in connection with the accompanying drawings.

### BRIEF DESCRIPTION OF THE DRAWINGS

FIG. 1 is a schematic block diagram of the primary components of the hardware and software configuration for the method or system of the present invention; and

FIG. 2 is a flow diagram illustrating the general sequence of steps associated with the preferred method or system of the present invention.

### DETAILED DESCRIPTION OF THE BEST MODES FOR CARRYING OUT THE INVENTION

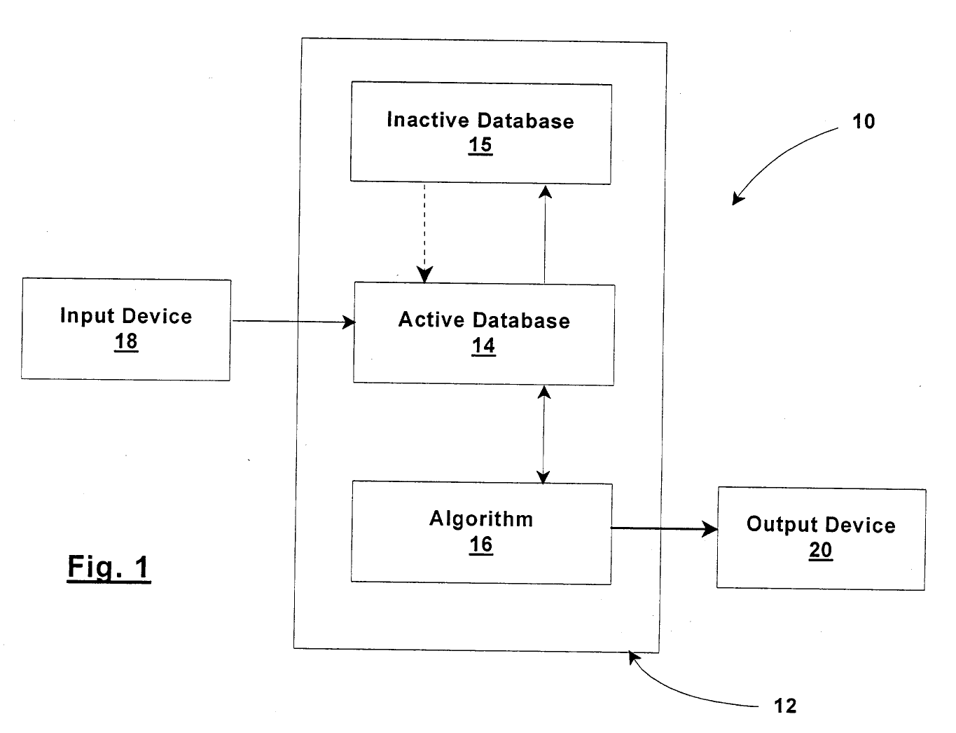

FIG. 1 shows a system or method 10 incorporating the present invention. The system 10 includes control logic 12 preferably in the form of a software program installed on a computer and having a storage device with appropriate software to handle an active database 14 for storing information therein, as will be described below, and a control algorithm 16 in the preferable form of software disposed on a computer for performing predetermined functions based on the information stored in the active database 14. The active database 14 may actually be one or more databases or files as defined by the user based on the actual hardware used and any efficiencies or capabilities that dictate designs or use. The active database 14 is here defined as the active information storage medium and related controls. A second inactive database 15 is also shown for storage of information determined by the system to be not likely to provide a purchase of product and/or services. Physically, the databases 14 and 15 may comprise one database storage medium with separate files or even some other configuration based on capabilities and efficiencies in the hardware and software used. It is preferred that the second inactive database 15 be separate here so that information aggregation and collection from the active database 14 be maintained as efficiently and speedily as possible. As described below in more detail, the flow of information is generally from the active database 14 to the inactive database 15, but on certain conditions (as indicated by the dotted line arrow of FIG. 1) information may return to the active database 14 from the inactive database 15. Software is intended to be included in the representation of FIG. 1 which controls access to, configuration of, and interaction between the databases 14 and 15, as well as other portions or steps of the system or method.

An input device 18, such as a keyboard and computer, is used to input information as data into the active database 14 in the storage medium. The information is usually analyzed or manipulated in some manner prior to input into the active database 14. The control logic 12 is further coupled to an output device 20 for providing information processed by an algorithm 16 for display or other use of output, such as provision of tapes to be converted to mailing lists, email lists, telephone number lists, or other communication related media. The algorithm 16 may select data on a single purchasing unit or an aggregate of purchasing units, as well as serveral variations of the types of information selected on a purchasing unit or an aggregate of purchasing units.

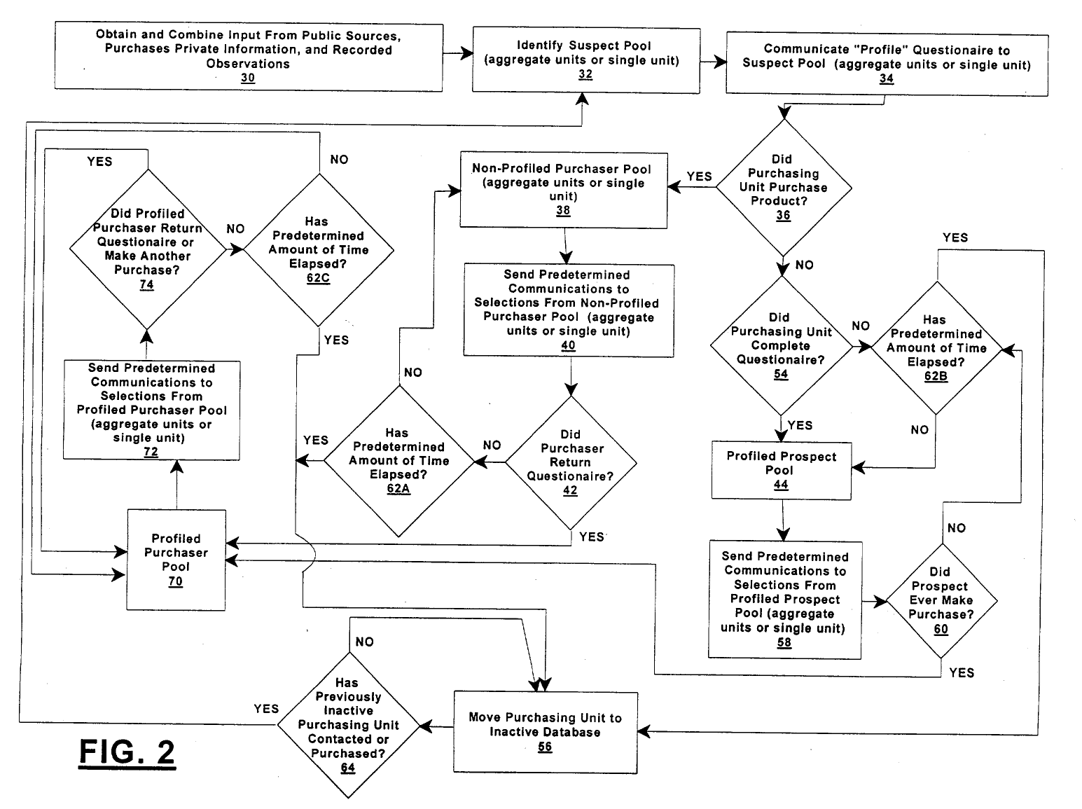

Turning now to FIG. 2, there is shown a flow diagram illustrating the general sequence of steps associated with the method of the present invention. The method begins with the step of obtaining a suspect pool, as shown at block 30. This step comprises a combination of three of the four categories of information on purchasing units included as input information into the system or method, combining information obtained information on purchasing units from (1) public sources (such as address, telephone number, driver's license number, etc.), (2) purchased information from private sources (credit information, prior purchases, a list of people who subscribe to a specific travel magazine, a list of people who have a specific credit card, etc.), and (3) recorded information on behavior and actions from observations of the purchasing unit interacting with the provider of the goods and/or services, the marketer of those goods and/or services, or others in the past. These three categories of information are combined with respect to each purchasing unit to form the initial input, although after the system or method has been in operation, supplementation or updates from the above three sources can also be included.

Next, the method proceeds to identify a suspect pool, as shown at block 32. This suspect pool is identified by comparing the information in the mass candidate list with predetermined criteria such as income, special interests, etc., to determine high probability prospects for the specific goods and/or services to be marketed.

A profile questionnaire is then sent to each of the purchasing units listed in the suspect pool, as shown at block 34. This questionnaire seeks information relevant to the sale of a particular product or service and is utilized to identify potential purchasing unit customers who may be actually interested in purchasing the goods and/or services being marketed.

Next, a determination is made as to whether or not any of the purchasing units in the suspect pool actually purchased the goods or services in the past, as shown at conditional block 36. If so, information about the purchasing units is stored in a non-profiled purchaser pool on the active database 14, as shown at block 38. At this point, predetermined marketing communications intended to obtain a sale or elicit the performance of a behavior or action, such as advertising, promotions, catalogs, and/or additional profiling questionnaires, are communicated to selected purchasing units in this non-profiled purchaser pool, as shown at block 40. These marketing communications are personalized to the specific buying patterns of each of the purchasing units based on a previous purchase of the goods or services at issue. Also included in the marketing is a profile questionnaire in hopes of obtaining additional information on behavior and other characteristics of the purchasing units, as the fourth input combined into the system or method. Therefore, a determination is made as to whether or not any of the purchasing units returned the subsequent questionnaire, as shown at conditional block 42. If the questionnaire is returned, information about the purchasing unit is stored in a profiled purchaser pool on the active database 14, as shown at block 70 and described in greater detail below.

If the purchasing unit from the non-profiled purchaser pool 38 has not returned some form of the profiling questionnaire or performed some other identified action or behavior, a determination is made as to whether or not a predetermined amount of time has elapsed at block 62A. If yes, information about the purchasing unit is transferred to an inactive status represented by the storage in the inactive database 15 (or an equivalent status) after a predetermined amount of time has elapsed, such as one year, two buying seasons, or similar parameters, as shown at conditional block 62A and block 56. At this point, no further communications are transmitted to the purchasing unit since the purchasing unit has a low probability of actually purchasing the goods or services being marketed.

If, however, any purchasing unit previously deemed to be inactive initiates communication by means of a potential customer contact with or a purchase from the seller, either of which being passive to the system or method, then information about the purchasing unit is re-entered into the active database 14, as set forth in conditional block 64, and sent back to the suspect pool at block 32, so that the purchasing unit could be re-evaluated. Alternatively, if a purchase is made, the purchasing unit can be placed into the non-profiled purchaser pool 38 (not shown directly), but would arrive there anyway subsequent to reevaluation via the flow of the system or method from the suspect pool at block 32.

Once the non-profiled purchaser pool (block 38) has been attained, whatever informational characteristics exist on that purchasing unit must be updated with current information. Predetermined communications are sent as a non-profiled purchaser (block 40) and a determination is made as to whether or not the purchasing unit returned the profile questionnaire, as shown at conditional block 42. If so, information about the purchasing unit is stored in the profiled purchaser pool 70 in the active database 15, as described below. If not, information about the purchasing unit is retained in the non-profiled purchaser pool in the active database 14 until a predetermined amount of time has elapsed from the subsequent purchase or from performing an identified action or behavior, via conditional block 62A.

Returning to conditional block 36, if the potential customer has not purchased the product or service at issue at the time of evaluation, a determination is made as to whether or not the purchasing unit did return the questionnaire, as shown at conditional block 54. If not, and a predetermined amount of time has elapsed (block 62B), information about the purchasing unit is moved to an inactive status, such as inactive database 15, at block 56, wherein no further marketing communications are transmitted to that purchasing unit.

If, however, the purchasing unit did return the questionnaire, information about the purchasing unit is stored in the profiled prospect pool in the active database 14, as shown at block 44. Now that more information is known about the purchasing unit as a potential purchaser, predetermined marketing communications can be transmitted to selected profiled prospect purchasing units, as shown at block 58, that are geared to each purchasing unit's specific interests, as determined from the purchasing unit's responses to the questionnaire. A determination is then made as to whether or not the profiled prospect purchasing unit has ever made a purchase, as shown at conditional block 60. If yes, information about the purchasing unit is retained in the profiled purchaser pool at block 70 in the active database 14, and the purchasing unit continues to receive selected predetermined marketing communications, as shown at block 72. However, if the purchasing unit has not made a purchase, information about the purchasing unit is moved to an inactive status, such as database 15, at block 56, after a predetermined amount of time, as shown at conditional block 62B.

The remaining steps involve purchasing units from the profiled purchaser pool 70. These purchasing units have the most information on the system or method and usually should be targeted as significant potential customers for future purchases. Purchasing units from the profiled purchaser pool 70 receive predetermined marketing communications, as shown at block 72. If the purchasing unit makes another purchase or returns a questionnaire, the purchasing unit re-enters the profiled purchaser pool at block 70. If the purchasing unit does not make another purchase nor return a questionnaire in a predetermined amount of time (conditional block 62C), the purchasing unit is moved to an inactive status at block 56. Since these purchasing units have the most information available, they also should be the best potential customers, and the predetermined time selected to elapse would in many cases be longer for block 62C than for blocks 62B or 62A. Each of the predetermined elapsed times can be different.

Thus, personalized or non-personalized marketing communications, such as catalog mailings, technical mailings, telemarketing, email, facsimiles, internet communications, and any other similar communications via an addressable medium can be communicated to potential customers having high probability of purchasing the goods and/or services being marketed by the marketer or the seller. Consequently, advertising costs are minimized since they will be incurred more selectively, and sales should increase, to generate higher profits and higher profits per sale.

Preferred embodiments have been disclosed. However, a person skilled in this art would recognize that modifications would come within the scope of this invention. For example, the present invention applies to major decision purchases of goods and/or services, as well as influencing a behavior, such as a visiting a park or taking a test drive of a vehicle. Thus, the following claims should be studied to determine the scope and content of this invention.

What is claimed is:

1. A method for marketing potential customers for major decision purchases based on knowledge of the potential purchasers, the method comprising:
transmitting a marketing profile questionnaire about specific areas of interest to predetermined purchasing units meeting minimum criteria;
determining if any of the predetermined purchasing units either make a specific purchase or return the marketing profile questionnaire;
if any one of the predetermined purchasing units purchase, subsequently transmitting predetermined marketing communications to each such purchasing unit based on the purchase;
if any one of the predetermined purchasing units return the marketing profile questionnaire, then transmitting predetermined marketing communications to each such purchasing unit who responds based on the purchasing unit responses to the marketing profile questionnaire; and
storing information about each purchasing unit who purchases and/or returns the questionnaire in a profiled prospect database.

2. The method as recited in claim 1 wherein if any one of the purchasing units do not return the marketing profile query and do not purchase the goods/services, then transferring information about each purchasing unit to an inactive status wherein marketing communications are no longer transmitted thereto unless said any one of the purchasing units initiates communication.

3. The method as recited in claim 2 wherein transmitting the predetermined marketing communications based on the purchase of the goods/services further comprises:
transmitting a subsequent marketing profile questionnaire;
determining if any of the purchasing units return the subsequent marketing profile questionnaire;
if so, storing information about the purchasing units in the profiled prospect database; and
if not, converting the information about the purchasing units to an inactive status after a predetermined amount of time.

4. The method as recited in claim 3 wherein prior to converting the information to an inactive status, the method further comprises:
determining if any one of the purchasing units made a subsequent purchase within a predetermined amount of time; and
if so, transmitting predetermined marketing communications based on the purchase.

5. The method as recited in claim 4 wherein transmitting the predetermined marketing communications includes transmitting the subsequent marketing profile questionnaire, wherein the method further comprises:
determining if any one of the purchasing units returned the subsequent marketing profile questionnaire;
if so, storing information about each purchasing unit who returned the questionnaire in the profiled prospect database; and
if not, determining if any of the purchasing units make another subsequent purchase within a predetermined amount of time.

6. The method as recited in claim 3 wherein storing the information in the profiled prospect database further includes transmitting predetermined marketing communications to the purchasing units based on their response to the marketing query and their previous purchase.

7. The method as recited in claim 6 wherein transmitting the predetermined marketing communications includes transmitting the predetermined marketing communications after a predetermined amount of time has elapsed from the previous purchase.

8. The method as recited in claim 1 further comprising:
determining if any one of the purchasing units in the profiled prospect database has made a purchase;
if not, converting the information about the purchasing units to an inactive status after a predetermined amount of time; and
if so, transmitting the predetermined marketing communications based on the response to the marketing profile questionnaire and the previous purchase by each of the purchasing units.

9. The method as recited in claim 1 wherein transmitting the marketing profile query comprising:
receiving a master list containing information about a plurality of purchasing units; and
comparing the information in the master list to predetermined factors associated with the specific purchase to compare the information on each purchasing unit with minimum threshold criteria.

10. The method as recited in claim 1 wherein transmitting the marketing profile query is performed electronically.

11. The method as recited in claim 1 wherein transmitting the marketing profile query is performed via a mail service.

12. A system for marketing potential customers for major decision purchases of goods or services based on knowledge of the potential customers, the system comprising:
means for transmitting a marketing profile questionnaire about specific purchases to predetermined purchasing units meeting minimum criteria; and
a control logic for determining if any of the predetermined purchasing units either make a purchase or return the marketing profile questionnaire, then initiating transmission of predetermined marketing communications to the purchasing or returning purchasing units based on the purchase information or the information on the returned questionnaire, then storing information about the purchasing units in a profiled prospect database; and initiating transmission of predetermined marketing communications to the purchasing units based on their response to the marketing profile questionnaire or their purchase.

13. The system as recited in claim 12 further comprising a file for inactive purchasing units in a database, wherein the control logic, if any one of the purchasing units do not return the marketing profile questionnaire and do not purchase, is further operative to transfer information about the purchasing units to said file for inactive purchasing units, wherein marketing communications are no longer transmitted thereto unless any one of the purchasing units located in the file of inactive purchasing units initiates communication.

14. The system as recited in claim 13 wherein the means for transmitting the predetermined marketing communications based on the purchase is further operative to transmit a subsequent marketing profile questionnaire, and wherein the control logic is further operative to determine if any of the purchasing units return the subsequent marketing profile questionnaire, and, if so, then store information about the purchasing units in the profiled prospect database if any of the purchasing units return the subsequent marketing profile questionnaire, and store information about the purchasing units in the inactive database after a predetermined amount of time if any one of the purchasing units do not return the subsequent marketing profile questionnaire.

15. The system as recited in claim 14 wherein prior to storing the information in the inactive database, the control logic is further operative to determine if any one of the purchasing units made a subsequent purchase within a predetermined amount of time and, if so, initiate transmission of the predetermined marketing communications based on the purchase.

16. The system as recited in claim 15 wherein the means for transmitting the predetermined marketing communications includes means for transmitting the subsequent marketing profile questionnaire and wherein the control logic is further operative to determine if any one of the purchasing units returned the subsequent marketing profile questionnaire, store information about the purchasing units in the profiled prospect database if any one of the purchasing units returned the subsequent marketing profile questionnaire, and determine if any of the purchasing units make another subsequent purchase within a predetermined amount of time if any of the purchasing units do not return the subsequent marketing profile questionnaire.

17. The system as recited in claim 14 wherein the control logic, in storing the information in the profiled prospect database, is further operative to initiate transmission of the predetermined marketing communications to an purchasing unit based on the purchasing unit's response to the marketing questionnaire or a purchase.

18. The system as recited in claim 17 wherein the control logic, in initiating transmission of the predetermined marketing communications, is further operative to initiate transmission of the predetermined marketing communications after a predetermined amount of time has elapsed from the purchase.

19. The system as recited in claim 12, further comprising a file of inactive purchasing units, wherein the control logic is further operative to determine if any one of the purchasing units in the profiled prospect database purchases, then store the information about said any one of the purchasing units in the file of inactive purchasing units after a predetermined amount of time if said any one of the purchasing units does not purchase, and then initiate transmission of the predetermined marketing communications based on the response to the marketing profile questionnaire and the previous purchase by said any one of the purchasing units if said any one of the purchasing units do purchase.

20. The system as recited in claim 12 wherein the control logic is further operative to receive a master list containing information about a plurality of purchasing units, and compare the information in the master list to predetermined factors associated with the specific purchase to determine whether the purchasing unit meets the minimum threshold criteria.

21. The system as recited in claim 12 wherein the means for transmitting the marketing profile questionnaire includes means for transmitting the marketing profile questionnaire electronically.

22. The system as recited in claim 21 wherein the means for transmitting is a facsimile.

23. The system as recited in claim 21 wherein the means for transmitting is correspondence over an electronic global information network.

24. The system as recited in claim 21 wherein the means for transmitting is an automated recording transmitted over a telephone network.

25. The system as recited in claim 21 wherein the means for transmitting the marketing profile questionnaire is the postal service.

26. The system as recited in claim 21 wherein the means for transmitting the marketing profile questionnaire is via telephone.

27. A method for marketing potential customers for major decision purchases based on knowledge of the potential purchasers, the method comprising:
creating an input by combining information on a purchasing unit from public sources, purchased private information, and recorded observations;
transmitting a marketing profile questionnaire about specific areas of interest to predetermined purchasing units meeting minimum criteria based on said input;
determining if any of the predetermined purchasing units either make a specific purchase or return the marketing profile questionnaire;
if any one of the predetermined purchasing units purchase, subsequently transmitting predetermined marketing communications to each such purchasing unit based on the purchase;
if any one of the predetermined purchasing units return the marketing profile questionnaire, then transmitting predetermined marketing communications to each such purchasing unit who responds based on the purchasing unit responses to the marketing profile questionnaire; and
storing information about each purchasing unit who purchases and/or returns the questionnaire in a profiled prospect database as a combination of said input with response information from said returned questionnaire and/or said purchase.
